(19) United States
(12) Patent Application Publication
(10) Pub. No.: US 2023/0007464 A1
(43) Pub. Date: Jan. 5, 2023

(54) METHOD AND APPARATUS FOR TRANSMITTING SERVICE PARAMETER

(71) Applicant: SAMSUNG ELECTRONICS CO., LTD., Suwon-si (KR)

(72) Inventors: Jicheol LEE, Suwon-si (KR); Hyesung KIM, Suwon-si (KR)

(21) Appl. No.: 17/809,505

(22) Filed: Jun. 28, 2022

(30) Foreign Application Priority Data
Jun. 30, 2021 (KR) 10-2021-0085749

(51) Int. Cl. H04W 8/12; H04L 43/0811; H04W 24/04

(52) U.S. Cl. CPC H04W 8/12; H04L 43/0811; H04W 24/04

(57) ABSTRACT

The disclosure relates to a 5G or 6G communication system for supporting a higher data transmission rate, and provides an apparatus and a method for transmitting service provisioning information to a UE when the UE is in a reachable state. An operation method of a policy control function (PCF) entity includes: receiving a data management message including a service parameter generated by an application function (AF) entity from a network exposure function (NEF) entity; transmitting an N1N2 message indicating to transmit the service parameter to a user equipment (UE) to an access and mobility management function (AMF) entity; receiving, from the AMF entity, a transfer result message indicating whether the service parameter has been transmitted to the UE; and transmitting the transfer result message to the AF entity.

### CROSS-REFERENCE TO RELATED APPLICATION(S)

This application is based on and claims priority under 35 U.S.C. 119 to Korean Patent Application No. 10-2021-0085749, filed on Jun. 30, 2021, in the Korean Intellectual Property Office, the disclosure of which is herein incorporated by reference in its entirety.

### BACKGROUND

1. Field

The disclosure relates to a wireless communication system and, more particularly, to an apparatus and a method for transmitting a service parameter of a UE in a cellular wireless communication system.

2. Description Of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Methods for delivering provisioning information in 3GPP network core networks have been standardized. In the process of provisioning a service parameter to a UE at the request of an application function (AF), service parameter provisioning fails if the UE is temporarily unreachable. The disclosure provides an apparatus and a method for transmitting service provisioning information to the UE when the UE is in a reachable state.

A method of operating a policy control function (PCF) entity according to various embodiments includes: receiving a data management message including a service parameter generated by an application function (AF) entity from a network exposure function (NEF) entity; transmitting an N1N2 message indicating to transmit the service parameter to a user equipment (UE) to an access and mobility management function (AMF) entity; receiving, from the AMF entity, a transfer result message indicating whether the service parameter has been transmitted to the UE; and transmitting the transfer result message to the AF entity.

The transfer result message may include reachability information indicating the reachability of the UE.

The reachability information may indicate whether the UE is temporarily unreachable.

According to the operation method, the N1N2 message may be retransmitted to the AMF entity when the reachability information indicates that the UE is temporarily unreachable.

The data management message may further include timer information generated by the AF entity.

The N1N2 message may be retransmitted based on the timer information.

The reachability information may be received from the UE.

The reachability information may be determined based on a paging for the UE.

The reachability information may be determined based on non-access stratum (NAS) information received from a base station.

The data management message may include information indicating to transmit the service parameter based on the reachability information.

A policy control function (PCF) entity according to various embodiments includes a processor; a memory configured to store at least one instruction executed by the processor; and an interface configured to transmit or receive a signal to or from another entity. The processor is configured to receive a data management message including a service parameter generated by an application function (AF) entity from a network exposure function (NEF) entity, transmit an N1N2 message indicating to transmit the service parameter to a user equipment (UE) to an access and mobility management function (AMF) entity, receive, from the AMF entity, a transfer result message indicating whether the service parameter has been transmitted to the UE, and transmit the transfer result message to the AF entity.

According to the disclosure, an AF transmits a service parameter to be delivered to a UE to a network entity. If the UE is temporarily unreachable, the network entity may transmit the service parameter to the UE if the UE undergoes a state change to a reachable state.

According to the disclosure, an API function may be provided such that, if a UE is temporarily unreachable, an AF can determine whether to stand by until the UE is again reachable and then to retransmit or to report an error without the standby and not to retransmit. Therefore, the AF can stably provision a service parameter to the UE.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a conceptual diagram of a network architecture according to various embodiments;

FIG. 2 illustrates a flowchart of an operation sequence of a PCF 50 according to various embodiments;

FIG. 3 illustrates a flowchart of an AF request approval procedure according to various embodiments;

FIG. 4 illustrates a flowchart of a signal flow between network functions according to various embodiments;

FIG. 5 illustrates a flowchart of a procedure for a case in which a PCF 50 transmits a request for transfer of an N1N2 message including a UE policy to an AMF 60 and then receives a rejection of the N1N2 message transfer from the AMF 60 according to various embodiments;

FIG. 6 illustrates a flowchart of an operation of a PCF 50 after an AMF 60 determines that the N1N2 message transfer requested from the PCF 50 has failed and notifies of the message transfer failure according to various embodiments;

FIG. 7 illustrates a flowchart of an operation sequence of a PCF according to various embodiments;

FIG. 8 illustrates a flowchart of a method of retransmitting a UE policy by a PCF 50 when N1N2 message transfer from an AMF 60 has failed according to various embodiments;

FIG. 9 illustrates a flowchart of an operation of a PCF 50 when a maximum delay time for UE policy delivery expires according to various embodiments;

FIG. 10 illustrates a flowchart of an operation of a PCF 50 for performing UE policy retransmission using a policy control update trigger according to various embodiments;

FIG. 11 illustrates a flowchart of a flow of a retransmission operation of a PCF 50 when a UE policy delivery fails according to various embodiments;

FIG. 12 illustrates a flowchart of a procedure for notifying of a UE policy transfer failure after a maximum transmission delay time has elapsed according to various embodiments;

FIG. 13 illustrates a flowchart of a method of delivering a UE policy after waiting for switching of connectivity of a UE 80 according to various embodiments; and

FIG. 14 illustrates a block diagram of a network entity according to various embodiments.

### DETAILED DESCRIPTION

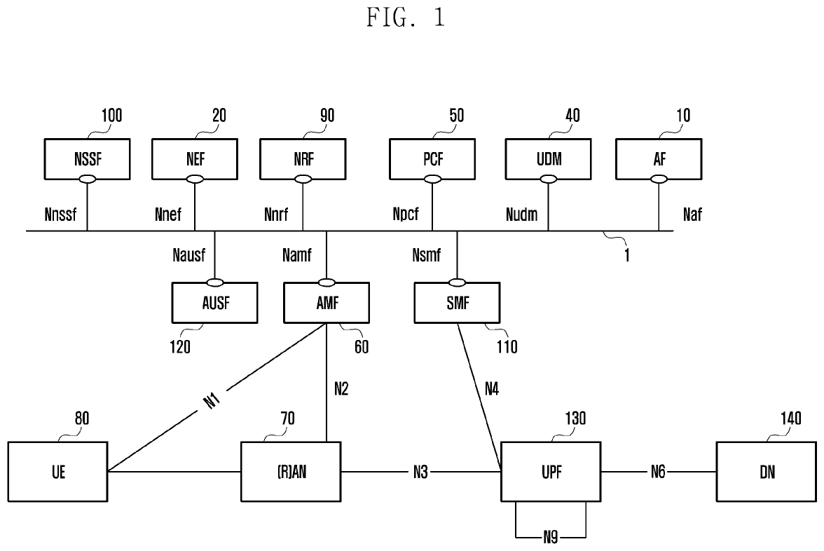

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail in conjunction with the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification. In the following description, a base station is an entity that allocates resources to terminals, and may be at least one of an eNode B, a Node B, a base station (BS), a radio access network (RAN), an access network (AN), a RAN node, a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Further, in the following description, LTE or LTE-A systems will be described by way of example, but the embodiments of the disclosure may also be applied to other communication systems having similar technical backgrounds or channel types. In addition, based on determinations by those skilled in the art, the embodiments of the disclosure may also be applied to other communication systems through some modifications without significantly departing from the scope of the disclosure.

FIG. 1 illustrates a conceptual diagram of a network architecture according to various embodiments.

Referring to FIG. 1, a 5G network system may include multiple network entities. For example, multiple network entities may include an application function (AF) 10, a network exposure function (NEF) 20, a unified data management (UDM) 40, a policy control function (PCF) 50, an access and mobility management function (AMF) 60, a (radio) access network ((R)AN) 70, a user equipment (UE) 80, a network repository function (NRF) 90, a network slice selection function (NSSF) 100, a session management function (SMF) 110, an authentication server function (AUSF) 120, a user plane function (UPF) 130, and a data network (DN) 140.

The AF 10, NEF 20, UDM 40, PCF 50, AMF 60, NRF 90, NSSF 100, SMF 110, and AUSF 120 may be interconnected through a public interface 1. For example, the public interface 1 may connect the AF 10, NEF 20, UDM 40, PCF 50, AMF 60, NRF 90, NSSF 100, SMF 110, and AUSF 120.

For example, the NEF 20 may be connected to the public interface 1 through an Nnef interface. The UDM 40 may be connected to the public interface 1 through an Nudm interface. The PCF 50 may be connected to the public interface 1 through an Npfc interface. The AMF 60 may be connected to the public interface 1 through an Namf interface. The (R)AN 70 may be connected to the AFM 60 through an N2 interface. The AFM 60 may be connected to the (R)AN 70 through the N2 interface.

The UE 80 may be connected to the AFM 60 through an N1 interface. The AFM 60 may be connected to the UE 80 through the N1 interface.

The NRF 90 may be connected to the public interface 1 through an Nnrf interface. The NSSF 100 may be connected to the public interface 1 through an Nnssf interface. The SMF 110 may be connected to the public interface 1 through an Nsmf interface. The AUSF 120 may be connected to the public interface 1 through an Nausf interface.

The UPF 130 may be connected to the SMF 110 through an N4 interface. The SMF 110 may be connected to the UPF 130 through the N4 interface. The UPF 130 may be connected to the (R)AN 70 through an N3 interface. The (R)AN 70 may be connected to the UPF 130 through the N3 interface. The UPF 130 may be connected to the DN 140 through an N6 interface. The DN 140 may be connected to the UPF 130 through an N6 interface.

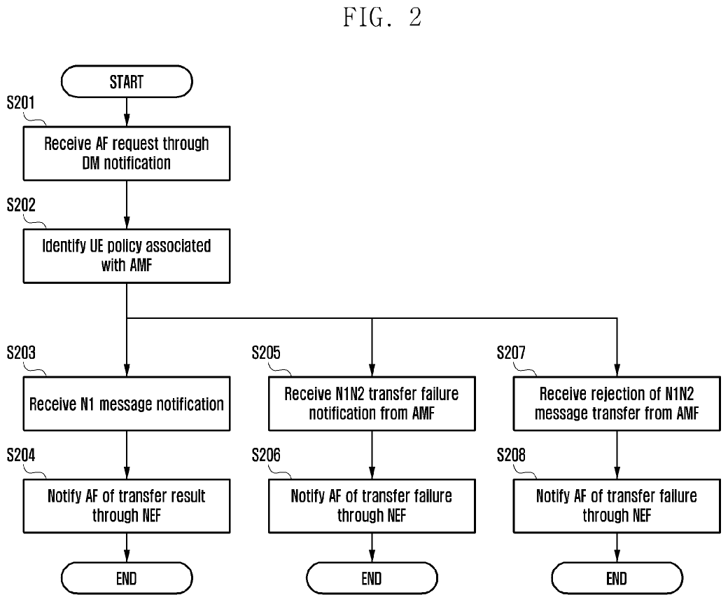

FIG. 2 illustrates a flowchart of an operation sequence of a PCF 50 according to various embodiments of the disclosure.

According to various embodiments, the PCF 50 may receive, from an AF 10, a service parameter provisioning request requested by the AF 10. The PCF 50 may transfer a service parameter, which has been received from the AF 10, to the AMF 60. The PCF 50 may determine whether the service parameter transfer has been successful, based on information received from an AMF 60. The PCF 50 may report whether the service parameter transfer has been successful to the AF 10 through an NEF 20.

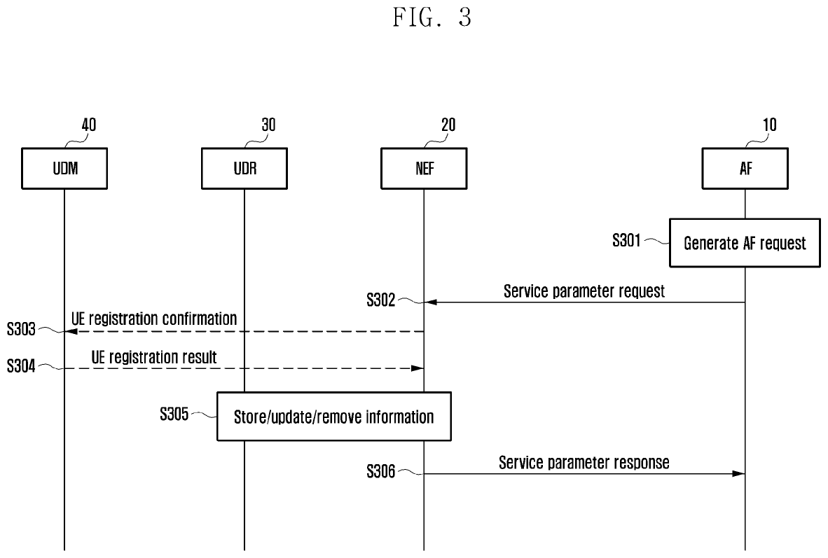

The NEF 20 may receive an AF request. The NEF 20 may apply for approval of the AF request from the UDM 40. Upon approval, the UDM 40 may consider whether a UE 80 is registered and whether the UE is roaming. In addition, when the UE 80 is not registered, the UDM 40 may identify whether the UE 10 has subscribed to a data network name (DNN)/single network slice selection assistance information (S-NSSAI). For example, a signal flow between the NEF and the UDM will be described with reference to FIG. 3.

For example, referring to FIG. 2, when the NEF 20 transfers the AF request to a UDR, the PCF 50 may receive a data management (DM) notification message from the UDR so as to receive the AF request (operation S201). For example, the DM notification may include at least one of a service parameter, a report subscription, and a notification address. The PCF 50 may identify details included in the AF request.

The PCF 50 may identify whether there is a UE policy association for the UE 10 associated with the AMF 60 (operation S202). The PCF 50 may transfer an N1N2 message for the UE 10 to the AMF 60.

The PCF 50 may perform an operation corresponding to the following three cases according to the responses of the AMF 60 and the UE 80.

1) The PCF 50 may receive an N1 message notification (N1 Message Notify) from the AMF 60 (operation S203). A policy container may be received from the UE 80. For example, when the UE policy is delivered to the UE 80, the PCF 50 may receive a result of transmission for the UE policy from the UE 80. The PCF 50 may transmit the transmission result to the AF 10 through the NEF 20 (operation S204). For example, the PCF 50 may receive a successful response to the N1N2 message. The AMF 60 may deliver the UE policy, which is successfully received from the PCF 50, to the UE 80 through the RAN 70. After successfully receiving the UE policy, the UE 80 may deliver a result of transmitting the UE policy to the PCF 50 through the AMF 60. The PCF 50 may receive whether the UE policy delivery is successful through the AMF 60.

2) The PCF 50 may receive an N1N2 transfer failure notification from the AMF 60 (operation S203). For example, the PCF 50 may receive, from the AMF 60, a successful N1N2 transfer request. The PCF 50 may receive the N1N2 message transfer failure notification from the AMF 60 when the AMF 60 fails to deliver the UE policy. For example, this may correspond to a case where the AMF 60 has failed to apply paging. The PCF 50 may notify the AF 10 of the delivery failure through the NEF 20 (operation S206). For example, the delivery failure may indicate that the N1N2 message is not reachable to the UE 10.

3) The PCF 50 may receive a rejection of the N1N2 message transfer request from the AMF 60 (operation S207). For example, when the UE 80 is not reachable from the AMF 60 or the UE 80 is located in an area where transmission/reception is not allowed and thus the AMF 60 enables the UE 80 to be reachable for regulatory prioritized services, the PCF 50 may receive a rejection from the AMF 60. The PCF 50 may notify the AF 10 of delivery failure through the NEF 20 (operation S208). For example, the delivery failure may indicate that the N1N2 message is unreachable to the UE, or that only a regulatory prioritized service is reachable.

The PCF 50 may transmit a result of UE policy delivery to the AF 10 through the NEF 20. When the UE policy delivery result has a value of “failure”, it may indicate whether a delivery has failed although the UE policy is attempted to be delivered to the UE 80, or whether a delivery failure occurs due to the connectivity of the UE 80. For example, through a result value for the UE policy delivery received from the UE 80, a rejection message for the UE policy delivery received from the AMF 60, or a failure notification message for the UE policy delivery, the PCF 50 may determine a UE policy delivery result value to be delivered to the AF 10. For example, the following details may be indicated as a result of UE policy delivery. The UE policy delivery result may include a reason for failure.

The UE policy delivery result may indicate successful UE policy delivery. For example, when the PCF 50 receives a result indicating the successful UE policy delivery from the UE 80, the PCF 50 may determine the UE policy delivery result as “successful UE policy delivery”.

The UE policy delivery result may indicate a failed UE policy delivery. For example, when the PCF 50 receives a rejection message for the UE policy delivery from the UE 80, the PCF 50 may determine the UE policy delivery result as failure. The reason of the failure of the UE policy delivery result may be expressed as UE rejection.

The UE policy delivery result may indicate the failed UE policy delivery. When the UE 80 is unreachable from the AMF 60 or the UE 80 is reachable only for regulatory prioritized services, the PCF 50 may determine the UE policy delivery result as failure. The PCF 50 may transfer the UE policy delivery result including the reason of the failure to the AF 10 through the NEF 20.

The UE policy delivery result may indicate a failed UE policy delivery. When the PCF 50 receives an N1N2 message transfer failure message from the AMF 60, the PCF 50 may determine the reason of the failure of the UE policy delivery result as the temporarily unreachable UE. The PCF 50 may transfer the UE policy delivery result including the reason of the failure to the AF 10 through the NEF 20.

FIG. 3 illustrates a flowchart of an AF request approval procedure according to various embodiments.

Referring to FIG. 3, an AF 10 may generate an AF request (operation S301). For example, the AF request may include information related to a service parameter.

The AF 10 may transmit a service parameter request to an NEF 20 (operation S302). For example, the service parameter request may include a request for at least one of creation, updating, and deletion of service parameters. The NEF 20 may receive the service parameter request from the AF 10. The NEF 20 may receive the AF request, and may apply for approval of the AF request from a UDM 40. The UDM 40 may determine approval based on at least one of whether a UE is registered, whether a UE is roaming, and whether or not to subscribe to DNN/S-NSSAI in case of any UE.

The NEF 20 may transmit a message requesting UE registration confirmation to the UDM 40 (operation S303). For example, the NEF 20 may transmit a message requesting approval for the AF request to the UDM 40. The message requesting approval for the AF request may include a message requesting UE registration confirmation. The UDM 40 may receive a message requesting approval for the AF request from the NEF 20.

The UDM 40 may transmit a UE registration result to the NEF 20 (operation S304). For example, the UDM 40 may determine whether to approve the AF request by considering the following details.

The UDM 40 may reject the approval for the AF request when the UE 80 is not registered. The UDM 40 may reject the approval for the AF request when the UE 80 is currently roaming. When the target UE 80 is an individual UE and the DNN/S-NSSAI is included in the parameters, the UDM 40 may identify whether the UE 80 is subscribed to the DNN/S-NSSAI. The UDM 40 may reject the approval for the AF request when the UE 80 is not subscribed.

When the target UE 80 is any UE or a group UE, the UDM 40 may convert the target UE 80 into an individual UE. The UDM 40 may return an individual UE list to the NEF 20 when the UE 80 is any UE and has been subscribed to the DNN/S-NSSAI. The UDM 40 may return the individual UE list to the NEF 20 when the UE 80 is a group UE. The UDM 40 may exclude a UE for which approval is not permitted from the list. Alternatively, the UDM 40 may separately transmit a list of UEs for which approval is not permitted to the NEF 20.

The NEF 20 may receive a result of approval for the AF request from the UDM 40.

The NEF 20 and the UDR 30 may perform operations for storing, updating, and removing information (operation S305). When the NEF 20 receives approval for the AF request from the UDM 40, the NEF 20 may store the AF request in the UDR 30.

The NEF 20 may transmit whether the AF request has been approved to the AF 10. For example, the NEF 20 may transmit a service parameter response to the AF 10. The service parameter response may include whether the AF request has been approved.

For example, the NEF 20 may receive whether the AF request has been approved from the UDM 40. The NEF 20 may receive a rejection of the authorization request from the UDM 40 when the AF request is not suitable. When the NEF 20 receives a rejection of the approval for the AF request from the UDM 40, the NEF 20 may transmit a response indicating a failure in service parameter creation or update to the AF 10. For example, a response message indicating the failure may include information regarding the reason for failure. For example, information regarding the reason for failure may indicate the following details.

The information regarding the reason of the failure may include information indicating that a UE is not registered. The information regarding the reason of the failure may include information indicating that a UE is currently roaming and that UE policy delivery is not permitted in a visited network. The information regarding the reason of the failure may include information indicating that the requested policy is not applicable because the requested factor is not subscribed to a target UE.

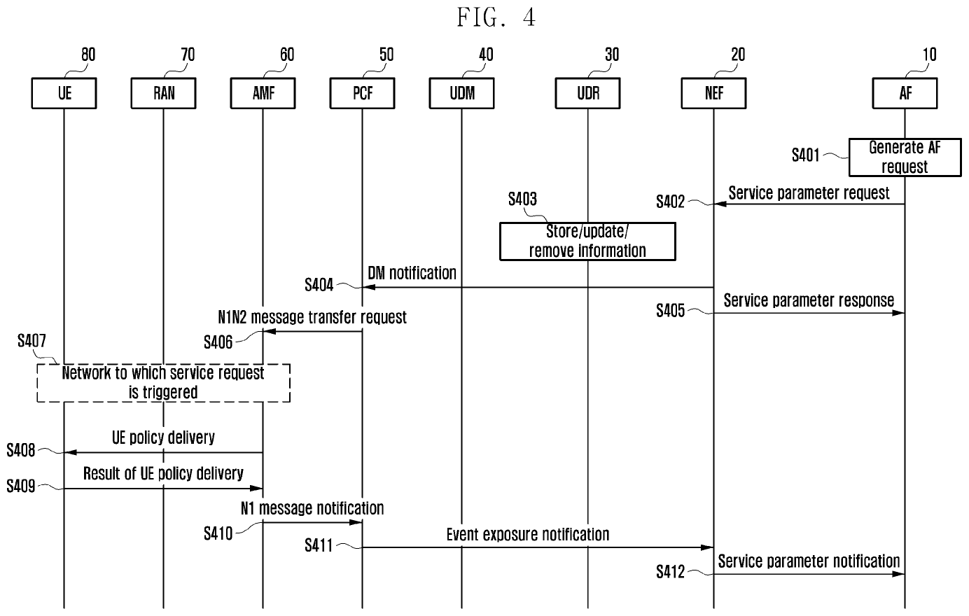

FIG. 4 illustrates a flowchart of a signal flow between network functions according to various embodiments.

According to various embodiments, a PCF 50 may receive an AF request. The PCF 50 may deliver a UE policy to a UE 80 through an AMF 60. The PCF 50 may receive a result of transmission from the UE 80. The PCF 50 may determine a UE policy transmission result based on the transmission result. The PCF 50 may deliver the UE policy delivery result to an AF 10 through a NEF 20. Referring to FIG. 4, the AF 10 may generate a service parameter provisioning request (operation S401). For example, the service parameter provisioning request may include at least one of information for service identification, service parameter information, information regarding a target UE, a target UE list, or a group UE, and event subscription request information.

For example, the information for service identification may be information for identifying a service to which a provided service parameter is applicable. Information for service identification may be expressed as at least one of a combination of DNN and S-NSSAI, an AF identifier, and an AF service identifier.

The service parameter information may be information on a service that can be identified based on information for service identification. For example, the service parameter information may indicate information which is prestored in a 5G core network and needs to be transmitted to the UE 80. The service parameter information may include at least one of an application traffic descriptor, information corresponding to a traffic descriptor for a UE route selection policy (URSP), a route selection parameter, DNN/S-NSSAI information, and route selection priority information.

The service parameter information may further include service-related information to be transmitted to the UE. For example, the service-related information to be delivered to the UE may include at least one of a UE route selection policy (URSP), an access network discovery and selection policy (ANDSP), and V2X configuration information.

The definition of a target UE, a target UE list, or a group UE may be as follows.

The target UE or group UE may refer to UEs to which service parameters need to be transmitted. An individual UE may be identified through a generic public subscription identifier (GPSI) or Internet protocol (IP) address, or an IP prefix or media access control (MAC) address.

The group UE may be classified by an external group ID.

When the target UE or group UE is not designated, the service parameter may be transmitted to all UEs using services classified by information for service identification.

The AF 10 may subscribe to a service parameter or UE policy delivery result notification service. For example, when the AF 10 makes an event subscription request, the event subscription request information may include reception address information by which the AF 10 may receive a report.

The AF 10 may transmit the AF request to the NEF 20 (operation S402). The NEF 20 may receive an AF request from the AF.

The NEF 20 and the UDR 30 may perform operations for storing, updating, and removing information (operation S403). For example, the NEF 20 may request approval for the AF request from the UDM 40. The UDM 40 may receive an authorization request for the AF request from the NEF 20. The UDM 40 may transmit a response to the approval request for the AF request to the NEF 20. The NEF 20 may perform an approval procedure for the AF request based on the response to the approval request for the AF request. For example, the approval procedure may be the same as or similar to that of FIG. 3.

For example, the NEF 20 may confirm the authority for the AF request and approve the AF request, by using a UDM service. When the AF request is approved, the NEF 20 may store information related thereto in the UDR 40.

The NEF 20 may transmit a DM notification to the PCF 50 (operation S404). The PCF 50 may receive the DM notification from the NEF 20. For example, the UDR 30 may transfer a DM notify message to the pre-subscribed PCF 50.

For example, the PCF 50 may receive a service parameter provisioning request from the AF 10, and may deliver an N1N2 message transfer request message to the AMF 60. For example, the PCF 50 having been subscribed to the DM notification may receive the DM notify message from the UDR 30 when the related AF request is stored in the UDR 30 by the NEF 20. The PCF 50 may receive service parameter information included in the AF request.

For example, the service parameter provisioning request may include information capable of identifying services (e.g., AF identifier, AF service identifier, or a combination of DNN and S-NSSAI), service parameter information to be provisioned to a network and transferred to the UE 80, target UE identification information, and notification service subscription request information for reporting of the UE policy delivery result.

The PCF 50 may determine a UE policy to be delivered to the UE 80 based on information included in the service parameter.

When the policy to be delivered to the UE 80 needs to be updated, the PCF 50 may perform a UE policy update procedure and deliver the updated UE policy information to the UE 80. The PCF 50 may transmit an N1N2 message transfer request message to the AMF 60 to perform a UE policy information update procedure.

The NEF 20 may transmit a service parameter response to the AF 10 (operation S405). The AF 10 may receive the service parameter response from the NEF 20.

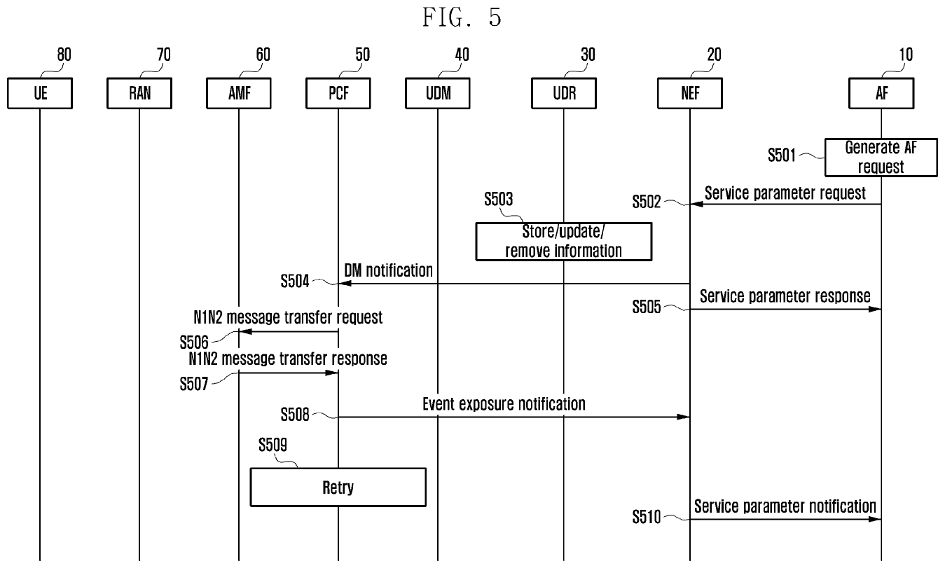

The PCF 50 may transmit an N1N2 message transfer request to the AMF 60 (operation S406). The AMF 60 may receive the N1N2 message transfer request from the PCF 50. For example, the PCF 50 may deliver a UE policy to the AMF 60 by utilizing the N1N2 message transfer service, which is provided by the AMF 60 to an individual UE. The AMF 60 may determine whether to reject the requested UE policy delivery request of the PCF 50, based on at least one of the registration state of a UE (whether UE is registered or not), the reachability of the UE, the loss or not of UE connectivity, the roaming state of the UE, the current location of the UE, and a procedure currently being performed by the UE. For example, FIG. 4 illustrates a procedure in which the AMF 60 successfully delivers a UE policy to the UE 80 according to various embodiments. FIG. 5 illustrates a procedure for a case in which the AMF 60 rejects message delivery according to various embodiments.

The AMF 60, the RAN 70, and the UE 80 may perform a network triggered service request operation (operation S407). For example, when the UE 80 is in an idle state, the AMF 60 may deliver the UE policy to the UE 80 after the UE 80 is switched to a connected state by performing a paging procedure.

The AMF 60 may transmit the UE policy to the UE 80 (operation S408). The UE 80 may receive the UE policy from the AMF 60. For example, the AMF 60 may transmit a NAS message for updating UE configuration to the UE 80. For example, the NAS message may include a UE policy. The UE 80 may receive the UE policy from the AMF 60. For example, the UE policy transmitted from the AMF 60 may be successfully transmitted to the UE 80. The UE 80 may store the UE policy when the UE policy is received.

The UE 80 may transmit a delivery result of the UE policy to the AMF 60 (operation S409). The AMF 60 may receive the UE policy delivery result from the UE 80. For example, when the UE 80 successfully receives the UE policy, the UE 80 may include a result of successful reception of the UE policy in a UE policy container and transmit the same to the AMF 60. For example, the UE 80 may transmit a transparent NAS message corresponding to the response message to the AMF 60.

The AMF 60 may transmit an N1 message notification to the PCF 50. The PCF 50 may receive the N1 message notification from the AMF 60. For example, the AMF 60 may transmit an N1 message reception notification message including the UE policy container, having been received from the UE 80, to the PCF 50. The AMF 60 may notify that the N1N2 message has been received from the UE 80. For example, the AMF 60 may transmit a notification message including the UE policy container, having been received from the UE 80, to the PCF 50. The PCF 50 may receive the UE policy container including the UE policy delivery result message, having been received from the UE 80, from the AMF 60. The UE policy delivery result message may indicate the successful UE policy delivery or failed UE policy delivery. When the UE 80 successfully receives the UE policy, the UE 80 may transmit a manage UE policy complete message to the PCF 50 through the AMF 60. When the UE 80 does not successfully receive the UE policy, the UE 80 may transmit a manage UE policy reject message to the PCF 50.

The PCF 50 may transmit an event exposure notification to the NEF 20 (operation S411). The NEF 20 may receive the event exposure notification from the PCF 50. For example, the PCF 50 may determine a result of the UE policy delivery, based on a UE policy delivery result received from the UE 80. For example, if the result received from the UE is success, the PCF 50 may determine that the UE policy delivery is successful. For example, if the result received from the UE is failure, the PCF 50 may determine that the UE policy delivery has failed. After determining the UE policy delivery result based on the transmission result received from the UE, the PCF 50 may transmit the UE policy delivery result to the AF 10 through the NEF 20. The PCF 50 may transmit the determined UE policy delivery result to the NEF 20.

The NEF 20 may transmit a service parameter notification message to the AF 10 (operation S412). The AF 10 may receive the service parameter notification message from the NEF 20. For example, the NEF 20 may determine that the AF 10 has requested the UE policy delivery result, which is received from the PCF 50. For example, the NEF 20 may determine the AF 10 based on a result notification address included in the AF request. The NEF 20 may transmit a notification message including the UE transmission policy delivery result to the determined AF 10.

FIG. 5 illustrates a flowchart of a procedure for a case in which a PCF 50 transmits a request for transfer of an N1N2 message including a UE policy to an AMF 60 and then receives rejection of the N1N2 message transfer from the AMF 60 according to various embodiments.

Referring to FIG. 5, operations S501 to S506 may be the same as or similar to operations S401 to S406 of FIG. 4.

The AMF 60 may transmit an N1N2 message transfer response to the PCF 50 (operation S507). The PCF 50 may receive the N1N2 message transfer response from the AMF 60. For example, the N1N2 message transfer response may indicate rejection of the N1N2 message transfer request. For example, the N1N2 message transfer response indicating rejection of the N1N2 message transfer request may indicate at least one of the following at least three rejection reasons.

For example, the N1N2 message transfer response may indicate at least one of a case in which the UE 80 is unreachable, a case in which the UE 80 is located in a non-allowed area and is reachable only for a regulatory prioritized service, and a case in which the UE 80 is rejected for a while because a registration procedure is being performed and a re-request is required after a guard time.

For example, in case that the N1N2 message transfer response indicates that the UE 80 is unreachable or the UE 80 is located in a non-allowed area, the PCF 50 may transmit an event exposure notification to the NEF 20 (operation S508). The NEF 20 may receive the event exposure notification from the PCF 50.

When the N1N2 message transfer response is rejected for a while, the PCF 50 may retry the N1N2 message transfer request after a guard time (operation S509).

When a rejection of the N1N2 message transfer is received from the AMF 60, the PCF 50 may determine the UE policy delivery as failure.

For example, in case that the UE 80 is unreachable since the UE is in a mobile initiated connection only (MICO) mode, or that the UE 80 is located in a non-allowed service area and is reachable only for a regulatory prioritized service, the AMF 60 may reject the N1N2 message transfer request of the PCF 50 in at least one of cases in which message transfer to the UE 80 is impossible and message transfer is possible after the guard time, while the AMF 60 is performing a relocation procedure.

The PCF 50 may receive, from the AMF 60, a rejection of the N1N2 message transfer service request. For example, in case that the rejection of the N1N2 message transfer service request indicates that message transfer to the UE 80 is temporarily impossible, and message transfer by the AMF 60 is possible after a designated time (guard time), the PCF 50 may retry message transfer after the guard time. However, in case that the rejection of the N1N2 message transfer service request indicates that the UE 80 is in an unreachable state or that the UE 80 is reachable only for regulatory prioritized services, the PCF 50 may determine that the UE policy delivery to the UE 80 has failed.

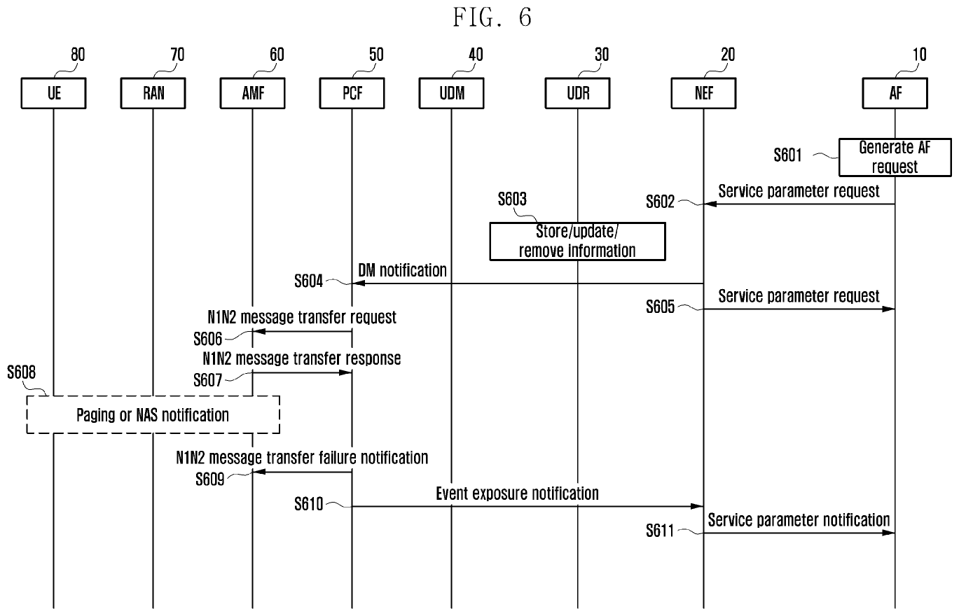

FIG. 6 illustrates a flowchart of an operation of a PCF 50 after an AMF 60 determines that the N1N2 message transfer requested from the PCF 50 has failed and notifies of the message transfer failure according to various embodiments.

Operations S601 to S606 may be the same as or similar to operations S401 to S406 of FIG. 4, or operations S501 to S506 of FIG. 5.

The AMF 60 may transmit an N1N2 message transfer response to the PCF 50 (operation S607). The PCF 50 may receive the N1N2 message transfer response from the AMF 60. For example, an N1N2 message transfer request may be successfully transferred from the PCF 50 to the AMF 60. For example, when the UE 80 is registered in at least one of 3GPP or Non-3GPP access and the UE is in a reachable state, the AMF 60 may transmit, to the PCF 50, the N1N2 message transfer response indicating that the N1N2 message transfer has been accepted.

The AMF 60, the RAN 70, and the UE 80 may perform a paging or NAS notification operation (operation S608). For example, the AMF 60 may start a paging procedure when the UE policy is determined to be delivered to the UE 80 through 3GPP access and the UE 80 is in a connection management (CM)-idle (IDLE) state. For example, the AMF 60 may attempt paging according to the paging policy of the AMF 60. The AMF 60 may determine that the paging has failed if there is no response from the UE 80 after the paging attempt. The AMF 60 may deliver an N1N2 message transfer failure notification message to the PCF 50.

The AMF 60 may transmit an N1N2 message transfer failure notification to the PCF 50 (operation S609). The PCF 50 may receive the N1N2 message transfer failure notification from the AMF 60. When the PCF 50 receives the N1N2 message transfer failure notification from the AMF 60, the UE policy delivery may be determined as failure.

The PCF 50 may transmit an event exposure notification to the NEF 20 (operation S610). The NEF 20 may receive the event exposure notification from the PCF 50. For example, the event exposure notification may include a message indicating that the UE 80 is not reachable. For example, the PCF 50 may transmit a message indicating that the UE 80 is not reachable to the AF through the NEF 20. A message indicating that the UE 80 is not reachable may be referred to as a delivery error message. The delivery error message may include a reason for the delivery error. For example, the reason for the transmission error may include details indicating that the UE 80 is unreachable.

The NEF 20 may transmit a service parameter notification to the AF 10 (operation S611). The AF 10 may receive the service parameter notification from the NEF 20. For example, after receiving the delivery error message from the PCF 50, the NEF 20 may determine an AF 10 related thereto and transmit the delivery error message to the AF 10.

The operation of the PCF 50 according to various embodiments has been described with reference to FIGS. 4, 5, and 6. By combining the details of FIGS. 4, 5, and 6, a method in which the PCF 50 determines transmission of a UE policy delivery failure notification is as follows.

When the PCF 50 determines the UE policy delivery as failure, the PCF 50 may transmit a UE policy delivery failure message to the NEF 20 based on the address of the NEF 20 stored in the UDR 30. The UE policy delivery failure notification message may include information indicating the reason for the transfer failure.

For example, in case that a rejection message is received from the UE 80 although the PCF 50 has successfully delivered the UE policy to the UE 80, the UE policy failure notification message may include information indicating that the UE policy delivery rejection by the UE is the reason of the delivery failure (“UE policy delivery is rejected by the UE”).

For example, in case that a response message is not received from the UE 80 although the PCF 50 has attempted to deliver the UE policy to the UE 80, the retransmission fails after performing a plurality of retransmissions and the number of retransmissions reaches a threshold, and thus the repetition of retransmission is stopped, the UE policy failure notification message may include information indicating the reason for the delivery failure such that the UE policy has been delivered but there is no response from the UE (“UE Policy delivery is requested, but no answer from the UE”).

For example, in case that the PCF 50 receives an N1N2 message transfer rejection message from the AMF 60 because the UE 80 is not reachable although the PCF 50 has delivered the UE policy to the AMF 60, the UE policy failure notification message may include information indicating the reason for the delivery failure such that the UE is currently not reachable or reachable only for regulatory prioritized services.

For example, in case that the PCF 50 has delivered the UE policy to the AMF 60, and the AMF 60 fails the UE policy delivery and receives an N1N2 message transfer failure notification although the AMF 60 performs a network initiated service request procedure including a paging procedure while the UE 80 is in an idle state so as to attempt to deliver the UE policy to the UE 80, the UE policy delivery failure notification message may include information indicating the reason for the delivery failure such that the UE is temporarily not reachable.

For example, with regard to the PCF 50, when the UE 80 that needs to receive the UE policy is not registered and there is no UE policy association, the UE policy delivery failure notification message may include information indicating the reason for the delivery failure such that the UE is not registered.

For example, in case that since the UE 80 that needs to receive the UE policy does not transmit the UE policy container, the UE policy association for the UE 80 does not exist in the PCF 50, the UE policy delivery failure notification message may include information indicating the reason for delivery failure such that the UE policy delivery is not supported by the UE 80.

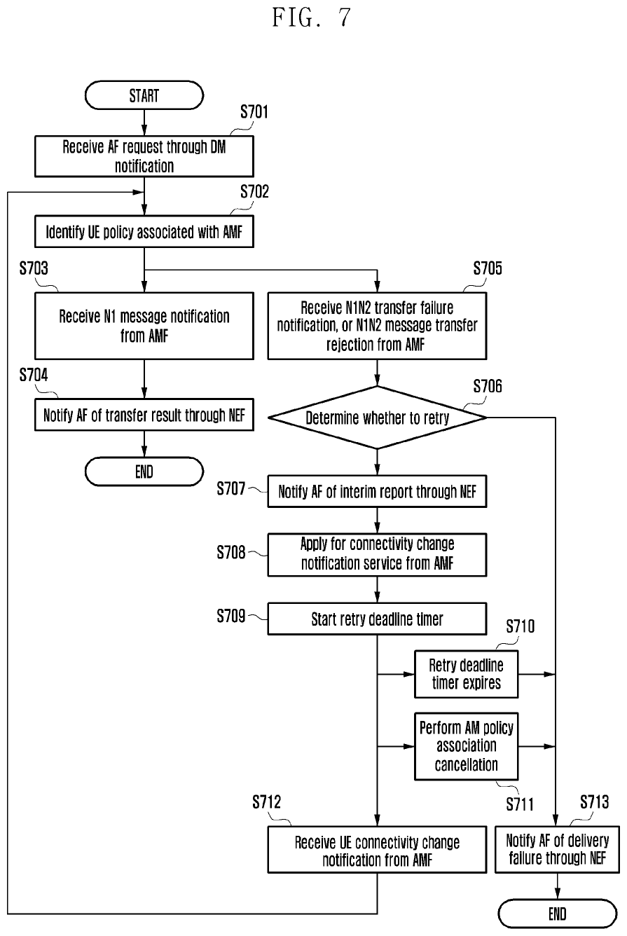

FIG. 7 illustrates a flowchart of an operation sequence of a PCF according to various embodiments.

According to various embodiments, an AF 10 may transmit an AF request including a retransmission request. According to various embodiments, the PCF 50 may retransmit a UE policy based on its own configuration. Referring to FIG. 7, the PCF 50 may receive the AF request through a DM notification (operation S701). For example, the AF 10 may generate an AF request including a UE policy that needs to be transmitted to the UE 80 or factors capable of generating the UE policy. The AF 10 may generate an AF request including a request for subscription to a result reporting service. For example, when the UE 80 is temporarily not reachable during delivering the UE policy to the UE 80, if the UE 80 become reachable, the AF request may include an indicator requesting retransmission of the UE policy to the UE 80 (UE policy retransmission request indicator). For example, when the UE policy request indicator is included in the AF request, the AF 10 may generate an AF request including the maximum allowable delay time (or UE policy delivery deadline). When generating an AF request including a retransmission request indicator, the AF 10 may further include, in the AF request, an indicator requesting to perform an interim report.

The AF 10 may generate an AF request including a UE policy creation factor and factors associated with a UE policy delivery result report request and a retransmission request. The AF 10 may deliver the AF request to the NEF 20. The NEF 20 may approve the AF request through the UDM 40. The UDM 40 may store the approved AF request in the UDR 30.

The PCF 50 may receive the AF request through a DM notify message generated from the UDR 30. For example, the DM notify message may include an AF request. The PCF 50 may generate a UE policy based on the AF request. When the PCF 50 needs to modify the UE policy and deliver the same to the UE 80, the PCF may transmit a request for the UE policy delivery to the AMF 60.

The PCF 50 may identify the UE policy association associated with the AMF 60 (operation S702). For example, the PCF 50 may receive a UE policy result from the UE 80 through the AMF 60. The PCF 50 may receive a UE policy delivery request rejection message from the AMF 60. The PCF 50 may receive a UE policy delivery failure notification.

The PCF 50 may receive an N1 message notification from the AMF 60 (operation S703). For example, the PCF 50 may receive a UE policy result from the UE 80 through the AMF 60. The AMF 60 may successfully deliver the UE policy to the UE 80. The AMF 60 may receive a UE policy delivery result from the UE 80. The AMF 60 may deliver the UE policy result received from the UE 80 to the PCF 50.

The PCF 50 may transmit the UE policy delivery result to the AF 10 through the NEF 20 (operation S704). The PCF 50 may receive, from the AMF 60, a rejection of UE policy delivery or a failure of UE policy delivery (operation S705). For example, the AMF 60 may reject a UE policy delivery request requested by the PCF 50. Alternatively, in case that the UE 80 does not respond although the AMF 60 attempts to perform a message delivery request, the AMF 60 may notify the PCF 50 that the message transfer has failed. For example, when the UE 80 is unreachable, the AMF 60 may transmit an N1N2 message transfer rejection to the PCF 50. Alternatively, when the UE 80 is in an idle state, the AMF 60 may attempt to deliver the UE policy to the UE 80 by performing a network initiated service request procedure. When the UE 80 does not respond to paging, the PCF 50 may notify the PCF 50 of an N1N2 message transfer failure notification.

The PCF 50 may determine whether to perform retransmission (operation S706). For example, when receiving a UE policy delivery rejection message from the AMF 60 or receiving a message delivery failure notification, the PCF 50 may determine whether to retransmit the UE policy based on a predetermined configuration or an indicator included in the AF request.

In case that the PCF 50 determines retransmission, the PCF 50 may request the AMF 60 to perform N1N2 message transfer in order to transmit the UE policy to the UE 80, when the UE 80 has been changed to a state of capable of receiving the UE policy (e.g., a CM-CONNECTED state or a reachable state), based on a maximum delay time for UE policy delivery (or UE policy delivery deadline) included in the AF request together with the UE policy retransmission request indicator.

The PCF 50 may notify the AF 10 of an interim report through the NEF 20 (operation S707). For example, when receiving a UE policy delivery rejection message from the AMF 60 or receiving a message delivery failure notification, the PCF 50 may determine whether to perform an interim report procedure. For example, when the PCF 50 determines to perform the interim report, the PCF 50 may transmit the interim report result including the reason for rejecting the policy delivery to the UE 80 or the UE policy failure reason to the AF 10 through the NEF 20.

The PCF 50 may apply for a connectivity change notification service from the AMF 60 (operation S708). In case that the PCF 50 determines to perform retransmission, when the UE 80 has been changed to a state in which UE policy delivery is possible, the PCF 50 may subscribe to a UE state change notification service capable of receiving, from the AMF 60, a notification that the state of the UE 80 has been changed, in order to retransmit the UE policy to the UE 80. For example, the UE state change notification service may include at least one service among a UE connectivity reporting service and a UE reachability reporting service.

The PCF 50 may perform a procedure of transmitting a subscription to a service for notification of a connectivity change of the UE 80 to the AMF 60. For example, the PCF 50 may receive a notification from the AMF 60 when the UE 80 is in a state capable of transmitting UE policy delivery. The PCF 50 may transmit the N1N2 message transfer request message including the UE policy to the AMF 60, so as to request the AMF 60 to transmit the UE policy to the UE 80.

The PCF 50 may receive the UE policy delivery result from the UE 80 through the AMF 60 after the PCF 50 has transmitted the retransmission request to the AMF 60. The PCF 50 may report the UE policy delivery result to the AF 10 through the NEF 20.

When the PCF 50 does not receive the UE policy delivery result from the UE 80 until a maximum delay time for UE policy (or UE policy delivery deadline), the PCF 50 may deliver a failure of the UE policy result and the reason of the failure to the AF 10 through the NEF 20. When the PCF 50 stores the result report address of the AF 10, the PCF 50 may directly transmit the result report to the AF 10 without going through the NEF 20.

The PCF 50 may start a retry deadline timer (operation S709). For example, the PCF 50 may drive an internal timer after transmitting, to the AMF 60, a subscription to a service for UE connectivity notification in order to detect a case in which a maximum delay time for UE policy has elapsed. The timer driven by the PCF 50 may be driven in the PCF 50 from a time point at which the DM notify message is received, in case that the AF request includes the maximum transmission delay time. For example, the maximum transmission delay time included in the AF request may be a value that can be expressed in units of seconds, minutes, or hours as a relative time from a time point at which the AF request is received.

For example, the AF request may include at least one of factors for a maximum delay time for UE policy and a UE policy delivery deadline. For example, the AF request may include a UE policy delivery deadline expressed in absolute time. For example, the UE policy delivery deadline expressed in absolute time and a maximum delay time for UE policy expressed in relative time may indicate a final time at which the UE policy is delivered.

For example, the PCF 50 may receive a DM notification and start an internal timer in order to detect a maximum delay time for UE policy or a UE policy delivery deadline. After transmitting a subscription to the UE connectivity reporting service to the AMF 60, the PCF 50 may drive a timer that expires at the remaining time of the maximum delay time or the UE policy delivery deadline.

The PCF 50 may determine the expiration of the retry deadline timer (operation S710). When the internal timer expires, the PCF 50 may determine the UE policy delivery result as failure. The PCF 50 may deliver the final report to the AF 10 through the NEF 20. For example, the final report may include information about a failure of the UE policy result and the reason of the failure. For example, when the PCF 50 stores the result report address of the AF 10, the PCF 50 may directly report the result to the AF 10 without going through the NEF 20.

The PCF 50 may perform an AM policy association cancellation operation (operation S711). The PCF 50 may receive a connectivity change notification of the UE 80 from the AMF 60 (operation S712). The PCF 50 may transmit, to the AF 10, a delivery failure indicating that transmission of the UE policy to the UE 80 has failed, through the NEF 20 (operation S713).

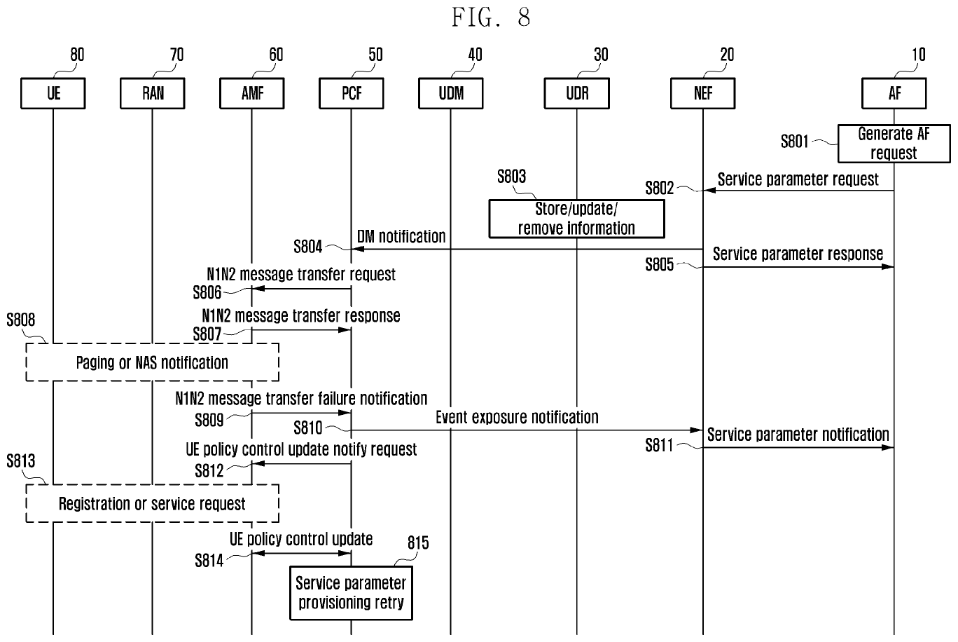

FIG. 8 illustrates a flowchart of a method of retransmitting a UE policy by a PCF 50 when N1N2 message transfer from an AMF 60 has failed according to various embodiments.

Referring to FIG. 8, an AF 10 may generate an AF request including a UE policy that needs to be transmitted to a UE 80 or factors capable of generating the UE policy (operation S801). For example, the AF 10 may generate an AF request that further includes a subscription request for a result reporting service.

For example, when the UE policy is transmitted to the UE 80, the UE 80 may be temporarily not reachable. The AF request may include an indicator (UE policy retransmission request indicator) requesting retransmission of the UE policy when the UE is reachable. For example, when the UE policy request indicator is included in the AF request, the AF request may include a maximum allowable delay time (or UE policy delivery deadline). For example, when the AF request includes the retransmission request indicator, the AF request may further include an indicator for requesting to perform an interim report. For example, the AF 10 may generate an AF request including a UE policy creation factor and factors associated with a UE policy delivery result report request and a retransmission request.

The AF 10 may transmit an AF request to the NEF 20 (operation S802). The NEF 20 may receive the AF request from the AF 10. The NEF 20 and the UDR 30 may store, update, and remove information (operation S803). For example, the NEF 20 may approve the AF request through the UDM 40. The NEF 20 may store the approved AF request in the UDR 30.

The NEF 20 may transmit a DM notification to the PCF 50 (operation S804). The PCF 50 may receive a DM notification from the NEF 20. For example, the PCF 50 may receive the AF request through a DM notify message generated from the UDR 30. The PCF 50 may create a UE policy. When the UE policy is modified and needs to be transmitted to the UE 80, the PCF 50 may request the UE policy delivery from the AMF 60.

The NEF 20 may transmit a service parameter response to the AF 10 (operation S805). The AF 10 may receive the service parameter response from the NEF 20. The PCF 50 may transmit an N1N2 message transfer request to the AMF 60 (operation S806). The AMF 60 may receive the N1N2 message transfer request from the PCF 50.

The AMF 60 may transmit an N1N2 message transfer response to the PCF 50 (operation S807). The PCF 50 may receive the N1N2 message transfer response from the AMF 60. For example, the PCF 50 may receive a UE policy result from the UE 80 through the AMF 60. The PCF 50 may receive a UE policy delivery request rejection message or a UE policy delivery failure notification from the AMF 60.

When receiving the UE policy result from the UE 80 through the AMF 60, the PCF 50 may perform the following operation. The AMF 60 may successfully deliver the UE policy to the UE 80. The AMF 60 may receive a UE policy delivery result from the UE 80. The AMF 60 may deliver the UE policy result, which is received from the UE 80, to the PCF 50.

When receiving a transmission rejection or transfer failure from the AMF 60, the PCF 50 may perform the following operation. The AMF 60 may reject the UE policy delivery request which is requested by the PCF 50, or may notify the PCF 50 of failure of message transfer when an attempt is made to perform a message delivery request but the UE 80 does not respond thereto.

For example, the AMF 60 may determine the reachability of the UE 80 through the current location and state of the UE 80 and subscriber information. For example, the AMF 60 may reject the transmission request of the PCF 50 when the UE 80 is not reachable at the current location or the UE is reachable only for regulatory prioritized services. For example, when the UE 80 is unreachable, the AMF 60 may notify the PCF 50 that the transmission of the N1N2 message is rejected.

The AMF 60, the RAN 70, and the UE 80 may perform a paging or NAS notification procedure (operation S808). For example, when the UE 80 is in an idle state, the AMF 60 may perform a network initiated service request procedure so as to transmit a UE policy to the UE 80.

The AMF 60 may transmit an N1N2 message transfer failure notification to the PCF 50 (operation S809). The PCF 50 may receive the N1N2 message transfer failure notification from the AMF 60. For example, in case that the UE 80 does not respond to paging although the AMF 60 attempts the paging to the UE 80, the AMF 60 may transmit, to the PCF, the N1N2 message transfer failure notification indicating that the N1N2 message transfer has failed. The AMF 60 may determine that paging of the UE 80 has failed and that the UE 80 is unreachable. The AMF 60 may notify the PCF 50 that the N1N2 message transfer has failed.

The PCF 50 may transmit an event exposure notification to the NEF 20 (operation S810). For example, an event exposure notification may include an interim report. For example, the interim report may include information indicating that the UE 80 is temporarily unreachable. The NEF 20 may receive the event exposure notification from the PCF 50.

The PCF 50 may receive an N1N2 message transfer rejection message from the AMF 60. The PCF 50 may receive an N1N2 message transfer failure notification from the AMF 60.

The PCF 50 may determine whether to retransmit the N1N2 message. For example, when the retransmission request indicator is included in the AF request, the PCF 50 may determine retransmission of the N1N2 message. When the retransmission request indicator is not included in the AF request, the PCF 50 may determine whether to retransmit the N1N2 message based on at least one of the preconfigured PCF configuration or the operator's configuration, or the operator policy of the PCF 50 pre-stored in the UDR 30.

When it is determined to perform retransmission, the PCF 50 may determine whether to perform an interim report. For example, when the AF request includes an interim report indicator, the PCF 50 generates an interim report including the current state of the UE 80 and the reason for transfer failure, and information indicating that retransmission has been attempted later. The PCF 50 may transfer the interim report to the AF 10 through the NEF 20. When the report reception address of the AF 10 is pre-stored, the PCF 50 may directly transmit the interim report to the AF 10.

The PCF 50 may transmit an event exposure notification including an interim report to the NEF 20. For example, the event exposure notification may include information indicating that the UE 80 is currently temporarily not reachable. The event exposure notification may further include information notifying that retransmission has been performed when the state of the UE 80 is changed in the future.

The NEF 20 may transmit a service parameter notification to the AF 10 (operation S811). For example, the service parameter notification may include an event exposure notification. For example, the service parameter notification may include an interim report. The AF 10 may receive the service parameter notification from the NEF 20. For example, the NEF 20 may determine an address to be exposed to the AF 10 based on information associated with the AF request. The NEF 20 may transmit the event exposure notification received from the PCF 50 to the AF 10 based on the determined address.

The PCF 50 may transmit a UE policy control update notify request to the AFM 60 (operation S812). The AFM 60 may receive the UE policy control update notification request from the PCF 50.

For example, when the PCF 50 does not subscribe to a service for notifying of the connectivity of the UE 80, the PCF 50 may subscribe to the notification service. For example, the UE policy control update notification request may include information indicating to transmit the UE policy control update to the PCF 50 when the connectivity of the UE 80 has been changed.

The AMF 60 may perform a registration or service request procedure through the RAN 70 and the UE 80 (operation S813).

The AMF 60 may receive a UE policy control update request from the PCF 50 and detect whether the connectivity of the UE 80 has been changed. For example, the AMF 60 may perform a service request procedure or a registration procedure for the UE 80. When the service request procedure or the registration procedure for the UE 80 is completed, the AMF 60 may receive information about the connectivity of the UE 80 from the UE 80. For example, the information about the connectivity may indicate whether the UE 80 is switched to a connected state, and whether the UE 80 is in a reachable state capable of receiving a UE policy. The AMF 60 may determine whether the state of the UE 80 has been changed based on the information on the UE state.

The AMF 60 may transmit a UE policy control update to the PCF 50 (operation S814). For example, the UE policy control update may include information indicating that the connectivity of the UE 80 has been changed. The PCF 50 may receive the UE policy control update from the AMF 60. When the connectivity of the UE 80 has been changed, the AMF 60 may transmit the UE policy control update including information indicating that the connectivity of the UE 80 has been changed to the PCF 50, which has subscribed to the UE connectivity reporting service.

The PCF 50 may perform a service parameter provisioning retry operation (operation S815). For example, upon receiving a report indicating that the UE 80 is in a reachable state from the AMF 60, the PCF 50 may return to operation S806 and transmit an N1N2 message transfer request to the AMF 60. The AMF 60 may receive the N1N2 message transfer request from the PCF 50.

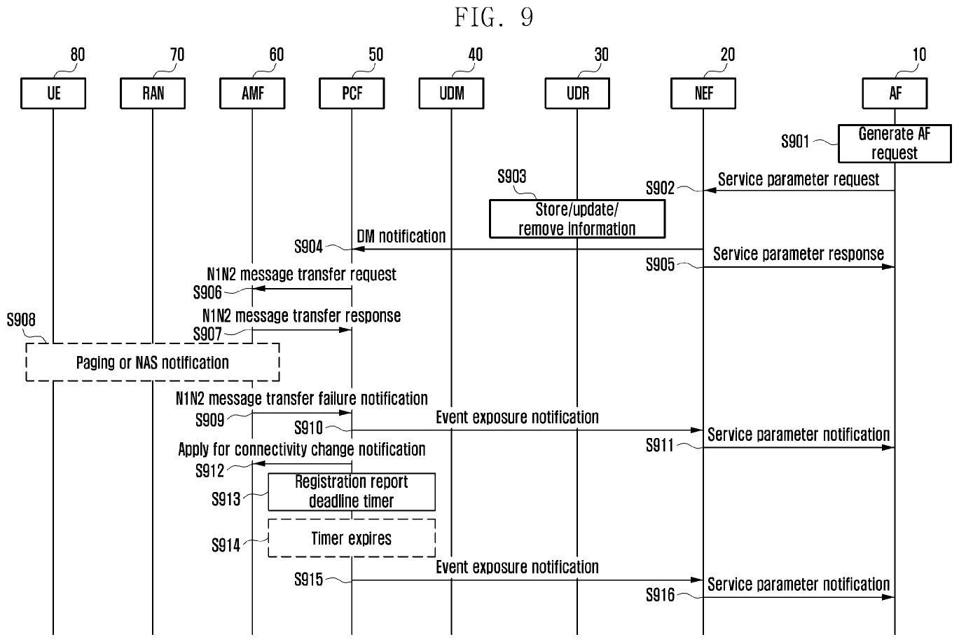

FIG. 9 illustrates a flowchart of an operation of the PCF 50 when the maximum delay time of UE policy delivery expires according to various embodiments.

The PCF 50 may attempt retransmission based on a timer. For example, the PCF 50 may receive the AF request including a retransmission indicator and a maximum transmission delay time value for a UE policy delivery. The PCF 50 may determine the maximum delay time value based on at least one of a pre-stored configuration or operator policy, or a policy storage database stored in the UDR 30. The PCF 50 may attempt retransmission based on the maximum delay time. For example, the PCF 50 may drive a timer when receiving a DM notification or transmitting a subscription to a UE connectivity change notification to the AMF 60. The PCF 50 may transmit a UE policy deliver failure when the maximum transmission delay time timer expires. For example, the UE policy deliver failure may include the reason of the failure. The PCF 50 may transmit a UE policy deliver failure including the reason of the failure to the AF 10 through the NEF 20.

Referring to FIG. 9, the AF 10 may generate an AF request (operation S901). For example, operation S901 may be the same as or similar to operation S801 of FIG. 8. The AF 10 may generate an AF request that further includes a maximum delay time factor for UE policy. The maximum delay time factor for UE policy may be referred to as a parameter indicating a retransmission expiration period.

Operations S902 to S903 may be the same as or similar to operations S801 to S802 of FIG. 8.

The NEF 20 may transmit a DM notification to the PCF 50 (operation S904). For example, the DM notification may include an AF request including a retransmission indicator and a parameter indicating a retransmission expiration period. The PCF 50 may receive the DM notification from the NEF 20.

Operations S905 to S912 may be the same as or similar to operations S805 to S812 of FIG. 8.

The PCF 50 may drive a registration report deadline timer (operation S913). For example, if the PCF 50 does not receive a UE policy delivery result from the UE 80 until a maximum delay time for UE policy (or UE policy delivery deadline), the PCF 50 may transmit a failure of the UE policy delivery result and the reason of the failure to the AF 10. When the result report address of the AF 10 is pre-stored, the PCF 50 may directly transmit the result report to the AF 10 without going through the NEF 20.

For example, the PCF 50 may drive an internal timer of the PCF 50 after transmitting a subscription to the UE connectivity reporting service to the AMF 60 in order to determine when a maximum delay time for UE policy has elapsed. For example, if the maximum transmission delay time corresponding to the timer value is included in the AF request, the PCF 50 may receive a DM notification including the AF request, and may start a timer based on the maximum transmission delay time. For example, the maximum transmission delay time may be expressed in units of seconds, minutes, or hours as a relative time from a time point at which the AF request is received.

For example, the AF request may include factors for a UE policy delivery deadline. For example, the UE policy delivery deadline may be expressed in absolute time. The UE policy delivery deadline expressed in absolute time and a maximum delay time for UE policy expressed in relative time may indicate a final time at which the UE policy is delivered, but is not limited thereto.

For example, the PCF 50 may receive a DM notification and start an internal timer based on the maximum delay time for UE policy or the UE policy delivery deadline. Alternatively, after transmitting a subscription to the UE connectivity reporting service to the AMF 60, the PCF 50 may configure a timer such that the timer expires at the remaining time of the maximum delay time or the UE policy delivery deadline. For example, the PCF 50 may drive a timer based on the transmission expiration time included in the AF request.

The PCF 50 may identify that the timer has expired (operation S914). For example, the timer may expire when at least one of the maximum delay time and the UE policy delivery deadline arrives.

The PCF 50 may transmit an event exposure notification to the NEF 20 (operation S915). The event exposure notifications may include a final report. The final report may include information indicating that the UE is unreachable. The NEF 20 may receive an event exposure notification from the PCF 50. For example, when the timer expires, the PCF 50 may generate a final report indicating that the service parameter cannot be transmitted because the UE 80 is not reachable. The PCF 50 may transmit an event exposure notification including the final report to the AF 10 through the NEF 20.

For example, when the internal timer expires, the PCF 50 may determine the UE policy delivery result as failure.

For example, the final report may include information on a failure of the UE policy result and the reason of the failure.

The NEF 20 may transmit a service parameter notification to the AF 10 (operation S916). For example, the NEF 20 may generate the service parameter notification based on the event exposure notification. The service parameter notification may include a final report. The AF 10 may receive the service parameter notification from the NEF 20.

When a result report address of the AF 10 is pre-stored, the PCF 50 may directly transmit the final report to the AF 10 without going through the NEF 20.

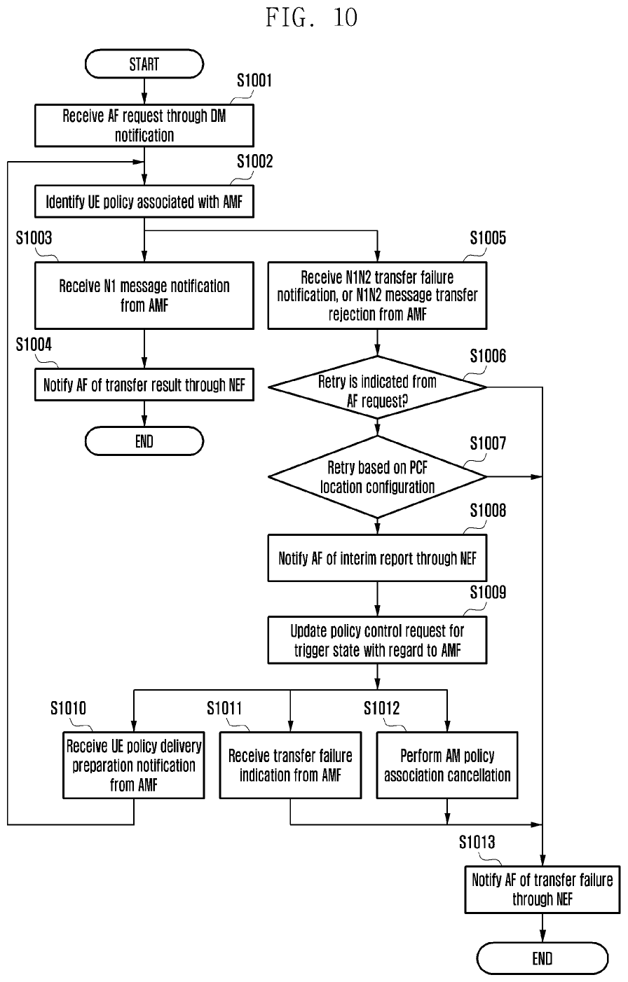

FIG. 10 illustrates a flowchart of an operation of the PCF 50 for performing UE policy retransmission using a policy control update trigger according to various embodiments.

Referring to FIG. 10, operations S1001 to S1005 may be the same as or similar to operations S701 to S705 of FIG. 7.

The PCF 50 may determine whether an indicator indicating retransmission for the UE policy is included in the AF request (operation S1006). For example, the PCF 50 may proceed to operation S1008 when the AF request includes an indicator indicating retransmission for the UE policy. If the AF request does not include an indicator indicating retransmission for the UE policy, the PCF 50 may proceed to operation S1013 and transmit a message indicating that the transmission of the UE policy has failed to the AF 10 through the NEF 20.

For example, the PCF 50 may transmit a new policy control update trigger to the AMF 60 based on the indicator. For example, when the UE 80 is changed to a state capable of receiving the UE policy control message, the policy control update trigger may include update procedure execution condition information by which the AMF 60 requests the PCF 50 to perform a policy control update procedure.

The PCF 50 may determine whether to retry the transmission of the UE policy based on the PCF location configuration (operation S1007). For example, the PCF location configuration may include information indicating at least one of timer information and the number of times of retry. The PCF 50 may retry the transmission of the UE policy.

For example, the PCF 50 may transmit the policy control update trigger to the AMF 60 based on a timer value pre-stored in the PCF 50 or a retransmission deadline included in the AF request.

For example, a policy control request trigger (PCRT) may be a report message indicating whether the UE 80 has been switched to a state capable of receiving the UE policy. For example, the policy control request trigger may include information indicating the maximum delay time for retransmitting the UE policy.

The PCF 50 may transmit an interim report to the AF 10 through the NEF 20 (operation S1008). For example, the interim report may include information indicating whether the UE 80 has received the UE policy. The interim report may include information indicating the connectivity of the UE 80.

The PCF 50 may update the policy control request to transmit the policy control request trigger to the AMF 60 (operation S1009). For example, the PCF 50 may transmit a policy control request trigger to the AMF 60.

The PCF 50 may receive a UE policy preparation notification from the AMF 60 (operation S1010). For example, the UE policy preparation notification may include information indicating that the UE 80 is in a connected state capable of receiving the UE policy.

For example, the AMF 60 may determine the connectivity of the UE 80 based on the policy control request trigger. When the UE 80 is switched to a state capable of receiving the UE policy through a transparent NAS, the AMF 60 may transmit information indicating that the UE 80 has been changed to a state capable of receiving the UE policy to the PCF 50. For example, when the UE 80 has entered a connected state or performed periodic registration, the AMF 60 may determine that the UE 80 is in a connected state. The PCF 50 may retransmit the UE policy stored in the UDR 30 to the AMF 60 based on a UE policy delivery preparation notification received from the AMF 60.

The PCF 50 may receive a transfer failure indication from the AFM 60 (operation S1011). For example, the transfer failure indication may indicate that transmission of the UE policy to the UE 80 has failed. For example, when the UE 80 is in a connected state in which the UE policy cannot be received after the maximum delay timer expires, the AMF 60 may transmit a policy control update request to the PCF 50. For example, the policy control update request may include the transfer failure indication.

The PCF 50 may cancel the AM policy association (operation S1012). The PCF 50 may transmit a message notifying of the transfer failure to the AF 10 through the NEF 20 (operation S1013). For example, the PCF 50 may receive, from the AMF 60, a policy control update request including reporting indicating that the UE 80 did not receive the UE policy and the maximum transmission delay time has expired. The PCF 50 may transmit, to the NEF 20, a message indicating that delivery of the UE policy to the UE 80 has failed. The NEF 20 may transmit, to the AF 10, a message reporting that delivery of the UE policy has failed. The NEF 20 may collect report messages and transmit the same to the AF 10.

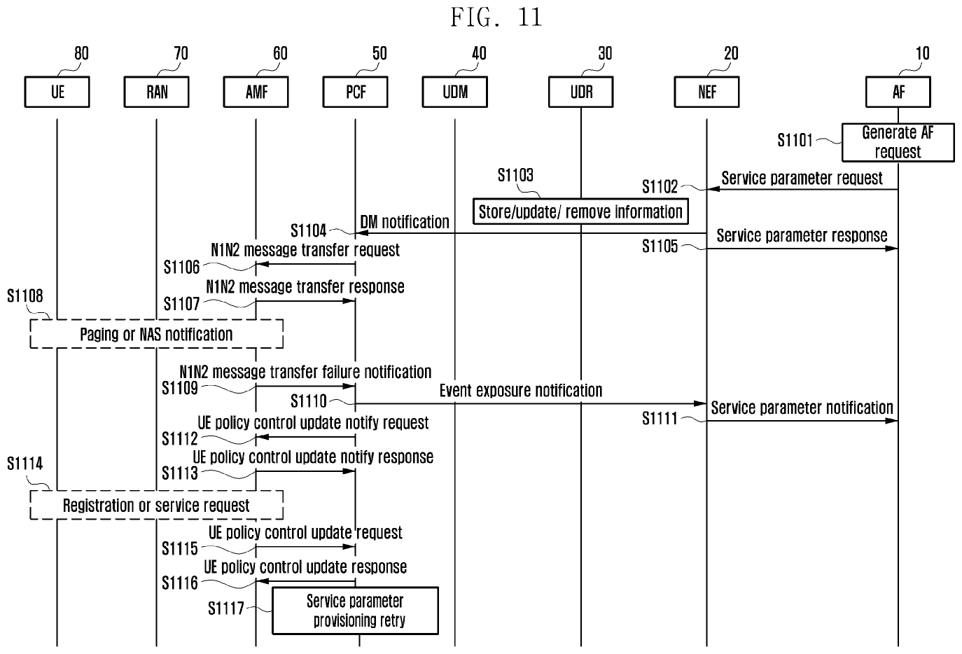

FIG. 11 illustrates a flowchart of a flow of a retransmission operation of a PCF 50 when a UE policy delivery fails according to various embodiments.

Referring to FIG. 11, operation S1101 may be the same as or similar to operation S801 of FIG. 8. For example, the AF 10 may generate an AF request including at least one of a retransmission request indicator for requesting a retransmission attempt when a UE is not connected, a maximum transmission delay time factor indicating a maximum transmission delay time, an interim report request indicator for requesting an interim report when an interim report needs to be transmitted (operation S1101).

Operations S1102 to S1104 may be the same as or similar to operations S802 to S804 of FIG. 8.

For example, the PCF 50 may receive, from an NEF 20, a DM notification including at least one of a retransmission request indicator, a maximum transmission delay time factor, and an interim report request indicator (operation S1104). The PCF 50 may identify at least one of a retransmission request indicator, a maximum transmission delay time factor, and an interim report request indicator based on the DM notification.

Operations S1105 to S1111 may be the same as or similar to operations S805 to S811 of FIG. 8.

The PCF 50 may transmit a UE policy control update notification request to an AMF 60 (operation S1112). The AMF 60 may receive the UE policy control update notification request from the PCF 50. For example, the UE policy control update notification request may include a request instructing to modify a policy control request trigger. For example, the policy control request trigger may be a report indicating that the UE 80 is switched to a state of capable of receiving the UE policy. For example, the request instructing to modify the policy control request trigger may include information about the maximum delay time for completing the UE policy.

The AMF 60 may transmit a UE policy control update notification response to the PCF 50 (operation S1113). The PCF 50 may receive the UE policy control update notification response from the AMF 60. The AMF 60 may perform a registration or service request operation through a RAN 70 and the UE 80 (operation S1114).

The AMF 60 may transmit a UE policy control update request to the PCF 50 (operation S1115). The PCF 50 may receive the UE policy control update request from the AMF 60. For example, the AMF 60 may transmit information indicating that the UE 80 has entered a state capable of receiving the UE policy to the PCF 50 through the transparent NAS based on the policy control request trigger. For example, the AMF 60 may transmit the information to the PCF 50 after the UE 80 has entered a connected state or performed periodic registration.

For example, the AMF 60 may detect whether the state of the UE 80 has been changed to a connected state of capable of delivering the UE policy.

The PCF 50 may transmit a UE policy control update response to the AFM 60 (operation S1116). For example, the PCF 50 may transmit the UE policy control update response to the AFM 60 based on a UE policy control update request. The AFM 60 may receive the UE policy control update response from the PCF 50.

The PCF 50 may perform a service parameter provisioning retry operation (operation S1117). For example, the UE policy control update request may include information indicating that the state of the UE 80 has been changed to a state capable of receiving the UE policy. The PCF 50 may transmit the UE policy stored in the UDR 30 to the AMF 60 based on information indicating that the state of the UE 80 has been changed to a state capable of receiving the UE policy. For example, the PCF 50 may return to operation S1106 and transmit an N1N2 message transfer request including the UE policy to the AMF 60.

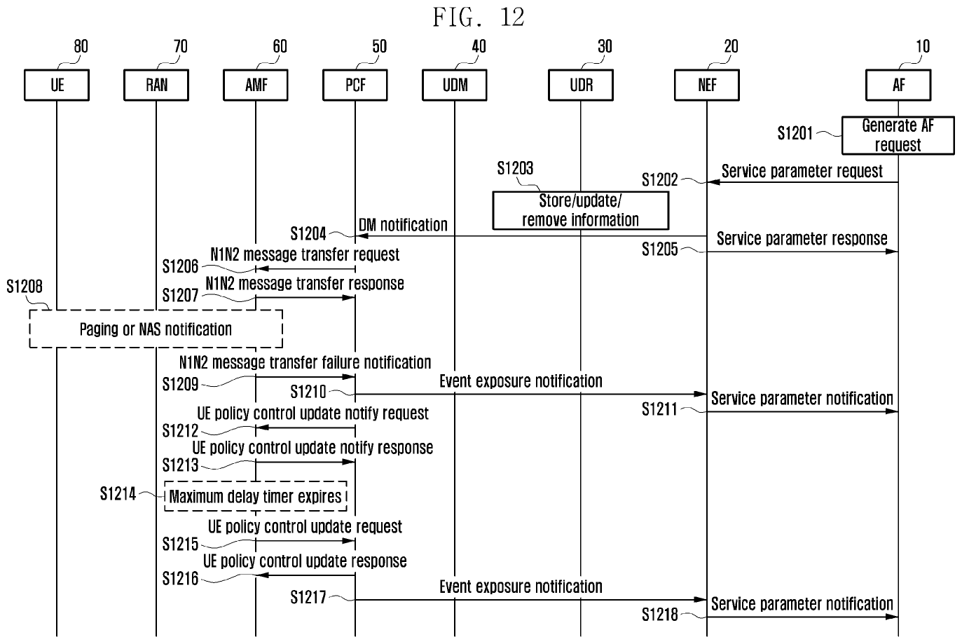

FIG. 12 illustrates a flowchart of a procedure for notifying of a UE policy transfer failure after a maximum transmission delay time has elapsed according to various embodiments.

Referring to FIG. 12, the AF 10 may generate an AF request including a maximum transmission delay time factor indicating a maximum transmission delay time (operation S1201).

Operations S1202 to S1211 may be the same as or similar to operations S1102 to S1111 of FIG. 11.

The PCF 50 may transmit a UE policy control update notification request to the AMF 60 (operation S1212). The AMF 60 may receive the UE policy control update notification request from the PCF 50.

For example, the UE policy control update notification request may include information requesting to modify a policy control request trigger. For example, the policy control request trigger may be a report message indicating whether the UE 80 is in a state of capable of receiving the UE policy. For example, the information requesting to modify the policy control request trigger may include information on the maximum delay time for completing the transfer of the UE policy.

The AMF 60 may transmit a UE policy control update notification response to the PCF 50 (operation S1213). For example, the AMF 60 may transmit the UE policy control update notification response to the PCF 50 based on the UE policy control update notification request. The PCF 50 may receive the UE policy control update notification response from the AMF 60.

For example, when the UE 80 is switched to a state capable of receiving the UE policy through a transparent NAS, the AMF 60 may transmit information indicating that the UE 80 has been changed to a state capable of receiving the UE policy to the PCF 50. For example, the AMF 60 may transmit the information to the PCF 50 after the UE 80 has been changed to a connected state or performed periodic registration.

The AMF 60 may determine that the maximum delay timer has expired (operation S1214). For example, the AMF 60 may determine that the maximum delay timer has expired based on the maximum transmission delay time factor.

The AMF 60 may transmit a UE policy control update request to the PCF 50 (operation S1215). The PCF 50 may receive the UE policy control update request from the AMF 60. For example, when the UE 80 is in a state not capable of receiving the UE policy after the maximum delay timer has expired, the AMF 60 may transmit the policy control update request to the PCF 50. For example, the UE policy control update request may include information indicating that the maximum transmission delay time timer has expired.

The PCF 50 may transmit a UE policy control update response to the AMF 60 (operation S1216). For example, the PCF 50 may transmit the UE policy control update response to the AMF 60 based on the UE policy control update request. The AMF 60 may receive the UE policy control update response from the PCF 50.

The PCF 50 may transmit an event exposure notification to the NEF 20. For example, the PCF 50 may generate the event exposure notification based on the UE policy control update request. For example, the PCF 50 may generate the event exposure notification based on information indicating that the maximum transmission delay time timer included in the UE policy control update request has expired. For example, the event exposure notification may include a final report indicating that transfer of the UE policy has failed. For example, the final report may include information indicating that the UE is unreachable.

The NEF 20 may transmit a service parameter notification to the AF 10 (operation S1218). For example, the NEF 20 may generate the service parameter notification based on the event exposure notification. For example, the service parameter notification may include information notifying that transfer of the UE policy has failed. For example, the service parameter notification may include information indicating that the UE is unreachable. The NEF 20 may transmit a plurality of service parameter notifications received from the NEF 20 to the AF 10.

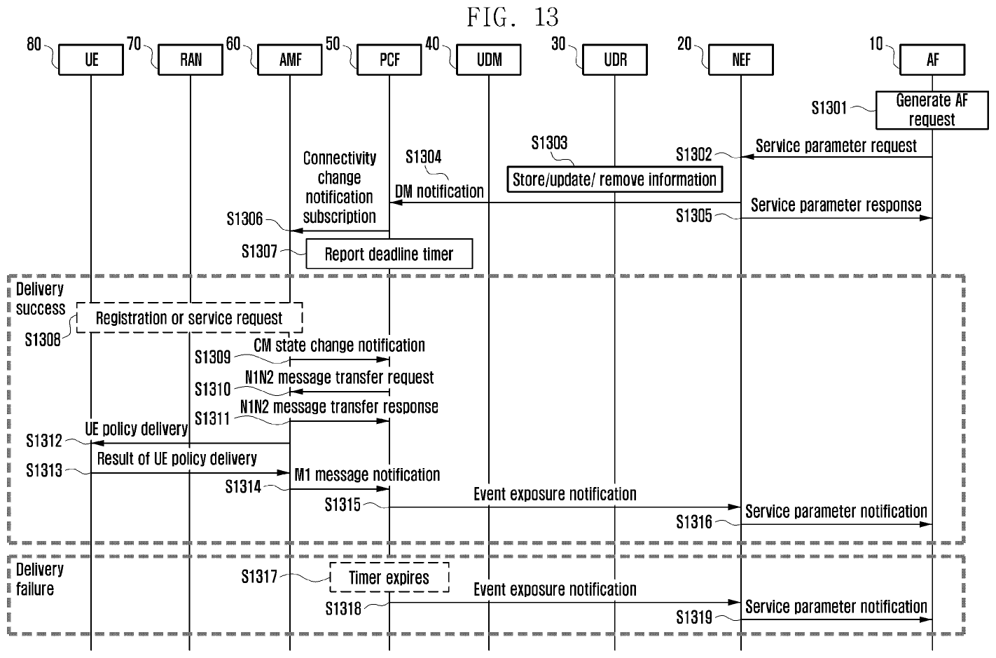

FIG. 13 illustrates a flowchart of a method of delivering a UE policy after waiting for switching of connectivity of a UE 80 according to various embodiments.

Referring to FIG. 13, the AF 10 may generate an AF request (operation S1301). For example, the AF request may include an indicator requesting to deliver a UE policy to the UE 80 when the UE 80 is in a connected state.

Operations S1303 to S1305 may be the same as or similar to operations S403 to S405 of FIG. 4.

The PCF 50 may transmit a subscription to a connectivity change notification to the AMF 60 (operation S1306). The AMF 60 may receive the connectivity change notification subscription from the PCF 50.

For example, the PCF 50 may transmit the connectivity change notification subscription to the AFM 60 based on a DM notification received from the NEF 20. For example, the DM notification may include an indicator requesting to transmit a UE policy to the UE 80 when the UE 80 is in a connected state. For example, when the PCF 50 is not subscribed to the connectivity change notification service, the PCF 50 may transmit the UE connectivity change notification subscription to the AMF 60.

The PCF 50 may register a reporting deadline timer (operation S1307). For example, the reporting deadline timer may be a timer that expires when the UE 80 is not changed to a connected state for a predetermined period of time.

The AMF 60 may perform a registration or service request operation through the RAN 70 and the UE 80 (operation S1308). For example, the AMF 60 may perform the registration or service request operation based on the connectivity change notification subscription received from the PCF 50. For example, the AMF 60 may detect the connectivity of the UE 80 after the registration or service request operation has been completed.

The AMF 60 may transmit a CM state change notification to the PCF 50 (operation S1309). For example, the AMF 60 may detect that the connectivity of the UE 80 has been changed to a CM-CONNECTED state. The AMF 60 may transmit the CM state change notification to the PCF 50 when the connectivity of the UE 80 has been changed to the CM-connected state. The PCF 50 may receive the CM state change notification from the AMF 60.

The PCF 50 may transmit an N1N2 message transfer request to the AMF 60 (operation S1310). For example, the PCF 50 may generate the N1N2 message transfer request based on a DM notification received from the NEF 20. For example, the N1N2 message may include a UE policy. The AMF 60 may receive the N1N2 message transfer request from the PCF 50.

The AMF 60 may transmit an N1N2 message transfer response to the PCF 50 (operation S1311). For example, the AMF 60 may transmit the N1N2 message transfer response to the PCF 50 based on the N1N2 message transfer request. The PCF 50 may receive an N1N2 message transfer response from the AMF 60.

The AMF 60 may transmit the UE policy to the UE 80 (operation S1312). For example, the AMF 60 may transmit the UE policy to the UE 80 based on the N1N2 message transfer request. The UE 80 may receive the UE policy from the AMF 60.

The UE 80 may transmit a result of delivering the UE policy to the AMF 60. For example, the UE 80 may transmit the UE policy delivery result to the AMF 60 based on the UE policy received from the AMF 60. For example, the delivery result may include information indicating that the UE 80 has received the UE policy. The AMF 60 may receive the UE policy delivery result from the UE 80.

The AMF 60 may transmit an N1 message notification to the PCF 50 (operation S1314). For example, the AMF 60 may generate an N1 message notification based on the UE policy delivery result received from the UE 80. The PCF 50 may receive the N1 message notification from the AMF 60.

The PCF 50 may transmit an event exposure notification to the NEF 20 (operation S1315). For example, the event exposure notification may be generated based on the N1 message. The NEF 20 may receive the event exposure notification from the PCF 50.

The NEF 20 may transmit a service parameter notification to the AF 10 (operation S1316). For example, the service parameter notification may be generated based on the event exposure notification. For example, the service parameter notification may include information indicating that the UE 80 has received the UE policy. The AF 10 may receive the service parameter notification from the NEF 20.

According to various embodiments, the PCF 50 may not receive the CM state change notification until a reporting deadline timer expires after registering the timer in operation S1307. Here, the PCF 50 may enter operation S1317 from operation S1307 so as to determine expiration of the timer (operation S1317). For example, when the state of the UE 80 is not changed to the connected state until the timer expires, the PCF 50 may determine that the service parameter delivery to the UE 80 has failed.

The PCF 50 may transmit the event exposure notification to the NEF 20 (operation S1318). For example, the PCF 50 may transmit the event exposure notification to the NEF 20 when the timer expires. For example, the event exposure notification may include information notifying that the service parameter delivery has failed. The NEF 20 may receive the event exposure notification from the PCF 50.

The NEF 20 may transmit a service parameter notification to the AF 10 (operation S1319). For example, the NEF 20 may generate the service parameter notification based on the event exposure notification. For example, the service parameter notification may include information indicating that the service parameter delivery to the UE 80 has failed.

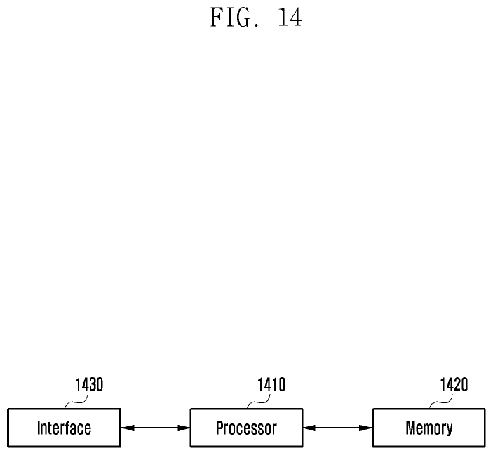

FIG. 14 illustrates a block diagram of a network entity according to various embodiments.

Referring to FIG. 14, the network entity may include a processor 1410, a memory 1420, and an interface 230. For example, the network entity may correspond to at least one of the AF10, NEF 20, UDM 40, PCF 50, AMF 60, (R)AN 70, UE 80, NRF 90, NSSF 100, SMF 110, AUSF 120, UPF 130, and DN 140. For example, the network entity may perform the operation of each network entity described with reference to FIGS. 1 to 13.

For example, the memory 1420 may store various instructions for executing various operations of the network entity. The processor 1410 may control the operation of the network entity. For example, the processor 1410 may execute various instructions stored in the memory 1420.

The interface 1430 may be connected to other network entities by wire or wirelessly. For example, the network entity may transmit or receive signals to or from other network entities through the interface 1430.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of operating a policy control function (PCF) entity, the method comprising:
receiving a data management notification message including a service parameter generated by an application function (AF) entity from a unified data repository (UDR) connected to a network exposure function (NEF) entity;
transmitting a user equipment (UE) policy including the service parameter for transmitting to a UE, to an access and mobility management function (AMF) entity;
receiving, from the AMF entity, a transfer result message indicating whether the UE policy has been transmitted to the UE; and
transmitting the transfer result message to the AF entity.

2. The method of claim 1, wherein the transfer result message is an N1N2 transfer failure notification message reporting that the UE policy has not been transmitted to the UE, in case that the UE is unreachable.

3. The method of claim 1, wherein the transfer result message notifies that a delivery of the UE policy is a failure because the UE is unreachable.

4. The method of claim 3, further comprising:
determining to retransmit the UE policy to the AMF entity when the UE is reachable; and
transmitting, to the NEF entity, an event exposure notification for reporting an interim status indicating that the UE is temporarily unreachable.

5. The method of claim 3, further comprising:
determining to retransmit the UE policy to the AMF entity when the UE is reachable; and
transmitting, to the AMF entity, an N1N2 message transfer request message for retransmitting the UE policy to the AMF entity when the UE is reachable.

6. The method of claim 3, further comprising:
transmitting, to the AMF entity, a message requesting notification of a connectivity state change of the UE; and
receiving, from the AMF entity, a message notifying of the connectivity state change of the UE when the UE is reachable.

7. The method of claim 3, further comprising:
determining that the delivery of the UE policy is a failure; and
transmitting, to the NEF entity, an event exposure notification message notifying that the delivery of the UE policy is a failure because the UE is unreachable.

8. A policy control function (PCF) entity comprising:
a processor;
a memory configured to store at least one instruction executed by the processor; and
an interface configured to transmit or receive a signal to or from another entity,
wherein the processor is configured to:
receive a data management notification message including a service parameter generated by an application function (AF) entity from a unified data repository (UDR) connected to a network exposure function (NEF) entity;
transmit a user equipment (UE) policy including the service parameter for transmitting to a UE, to an access and mobility management function (AMF) entity;
receive, from the AMF entity, a transfer result message indicating whether the UE policy has been transmitted to the UE; and
transmit the transfer result message to the AF entity.

9. The PCF entity of claim 8, wherein the transfer result message is an N1N2 transfer failure notification message reporting that the UE policy has not been transmitted to the UE, in case that the UE is unreachable.

10. The PCF entity of claim 8, wherein the transfer result message notifies that a delivery of the UE policy is a failure because the UE is unreachable.

11. The PCF entity of claim 10, wherein the processor is further configured to:
determine to retransmit the UE policy to the AMF entity when the UE is reachable; and
transmit, to the NEF entity, an event exposure notification for reporting an interim status indicating that the UE is temporarily unreachable.

12. The PCF entity of claim 10, wherein the processor is further configured to:
determine to retransmit the UE policy to the AMF entity when the UE is reachable; and
transmit, to the AMF entity, an N1N2 message transfer request message for retransmitting the UE policy to the AMF entity when the UE is reachable.

13. The PCF entity of claim 10, wherein the processor is further configured to:
transmit, to the AMF entity, a message requesting notification of a connectivity state change of the UE; and
receive, from the AMF entity, a message notifying of the connectivity state change of the UE when the UE is reachable.

14. The PCF entity of claim 10, wherein the processor is further configured to:
determine that the delivery of the UE policy is a failure; and
transmit, to the NEF entity, an event exposure notification message notifying that the delivery of the UE policy is a failure because the UE is unreachable.
